(19) United States
(12) Patent Application Publication
(10) Pub. No.: US 2020/0122395 A1
(43) Pub. Date: Apr. 23, 2020

(54) Material Straightening Device for Feeding Material to an Additive Manufacturing Machine

(71) Applicants: Jonathan R. Schroeder, South Beloit, IL (US); Timothy Joseph LeCrone, Rockford, IL (US); Joseph A. Binka, Belvidere, IL (US)

(72) Inventors: Jonathan R. Schroeder, South Beloit, IL (US); Timothy Joseph LeCrone, Rockford, IL (US); Joseph A. Binka, Belvidere, IL (US)

(73) Assignee: 3DP Unlimited, LLC d/b/a 3D Platform, Roscoe, IL (US)

(21) Appl. No.: 16/609,929

(22) PCT Filed: May 4, 2018
(86) PCT No.: PCT/US2018/031031

§ 371 Date: Oct. 31, 2019

Related U.S. Application Data
(60) Provisional application No. 62/502,277, filed on May 5, 2017.

(51) Int. Cl. B29C 64/321; B29C 64/295; B29C 64/118; B33Y 30/00; B29C 64/209

(52) U.S. Cl. CPC B29C 64/321; B29C 64/295; B29C 64/209; B33Y 30/00; B29C 64/118

(57) ABSTRACT

A filament straightener, an additive manufacturing machine including a filament straightener, and methods of straightening a filament are provided. The filament straightener includes abase member, a plurality of guide members attached to the base member. The plurality of guide members defines a filament flow path therebetween. The filament flow path extends between an inlet end and an outlet end. The guide members are spaced relative to the filament flow path to cause a filament passing along the filament flow path between the inlet end and the outlet end to experience a plurality of bends to remove curvature memory.

### FIELD OF THE INVENTION

This invention generally relates to additive manufacturing machines and particular devices for straightening a filament used in an additive manufacturing machine prior to being extruded.

### BACKGROUND OF THE INVENTION

Fused Filament Fabrication (FFF) extrusion additive manufacturing machines consume material (aka filament) that is wound up on spools for easy transport, storage and loading/feeding into the additive manufacturing machine. To date, the common diameters commonly used in the industry are 2.85 mm and smaller. At this diameter, the material is easily pliable and will straighten enough when uncoiled from the spool in order to be fed into the machine. In order to increase production rates, larger diameter filament (e.g. greater than 4.5 mm) is being used. Unfortunately, when larger diameter filament is uncoiled, there is often too much ‘memory’ in the material and a curve remains in the filament. This curve in the material makes it difficult to feed into the additive manufacturing machine and can cause jams within the additive manufacturing machine.

### BRIEF SUMMARY OF THE INVENTION

A filament straightener, an additive manufacturing machine including a filament straightener, and methods of straightening a filament are provided. The filament straightener includes a base member, a plurality of guide members attached to the base member. The plurality of guide members defines a filament flow path therebetween. The filament flow path extends between an inlet end and an outlet end. The guide members are spaced relative to the filament flow path to cause a filament passing along the filament flow path between the inlet end and the outlet end to experience a plurality of bends to remove curvature memory.

In a particular embodiment, at least one heater positioned adjacent the filament flow path to heat the filament as the filament passes from the inlet end toward the outlet end.

In a particular embodiment, the plurality of guide members is provided by a plurality of rollers. Each roller rotates about an axis of rotation that is generally perpendicular to the portion of the filament flow path defined by the corresponding roller.

In a particular embodiment, the rollers are driven by at least one motor to drive filament along the filament flow path.

In a particular embodiment, a feed mechanism drives the filament along the filament flow path.

In a particular embodiment, the plurality of guide members is a plurality of stationary posts.

In a particular embodiment, at least one guide member is adjustable mounted to the base member to adjust a position of the guide member in a transverse direction relative to the filament flow path.

In a particular embodiment, a spacing of the plurality of guide members is such that the filament is plastically deformed as the filament is bent.

In a particular embodiment, a bend sensor is downstream from the plurality of guide members. A controller is configured to adjust the spacing of the at least one guide member to adjust the amount of bend based on information from the bend sensor.

In a particular embodiment, a sizing die adjusts a size of the filament, before or after the guide members.

In a particular embodiment, a shaping die adjusts a shape of the filament, before or after the guide members.

In a particular embodiment, the plurality of guide members are positioned relative to the filament flow path such that a ratio of a radius of curvature of the filament before passing through the guide members to a radius of curvature of the filament after passing through the guide members is less than 50%.

In a particular embodiment, a cooling tube is downstream from the heater and downstream of the plurality of guide members.

In a particular embodiment, a heater is downstream from the plurality of guide members.

In one embodiment, a method of straightening filament for an additive manufacturing machine comprises passing filament through a straightener as outlined above. This will cause the filament to be repeatedly bent, preferably plastically deformed during the bending.

In one embodiment, an additive manufacturing machine is provided. The additive machine includes an extruder; a spool of filament upstream of the extruder; and a straightener as outlined above interposed between the extruder and the spool of filament.

In a particular embodiment, at least one heater positioned adjacent the filament flow path to heat the filament as the filament passes from the inlet end toward the outlet end.

In a particular embodiment, a cooling tube is downstream from the heater and downstream of the plurality of guide members and upstream of the filament extruder.

In a particular embodiment, the cooling tube is configured to allow the filament to set prior to entering the filament extruder. This may be done by a particular length or speed at which the filament is fed into the extruder.

In a particular embodiment, a filament relaxer is upstream of the straightener. The filament relaxer includes a tube through which the filament passes prior to entering the straightener as well as a heater for heating the tube to heat the filament prior to entering the straightener.

In another embodiment, a method of straightening a filament for use in an additive manufacturing machine includes repeatedly bending the filament to remove curvature memory in the filament prior to passing the filament to a filament extruder.

In a particular embodiment, repeatedly bending the filament utilizes a filament straightener as outlined above.

In a particular embodiment, the repeated bending of the filament includes bending the filament to a sufficient degree such that the filament is repeatedly plastically deformed.

In a particular embodiment, the method includes heating the filament during the step of repeatedly bending the filament.

In a particular embodiment, the method includes cooling the filament after the step of heating the filament and after repeatedly bending the filament. This step of cooling the filament can help set the filament in the straightened orientation to help maintain the straightening effects of the bending of the filament.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified illustration of an additive manufacturing machine according to an embodiment of the invention;

FIG. 2 is a simplified illustration of a representative filament extruder used in the additive manufacturing machine of FIG. 1;

FIG. 3 is a picture of a representative filament straightener used in the additive manufacturing machine of FIG. 1; and

FIG. 4 is a simplified cross-sectional illustration of a guide member used in the filament straightener of FIG. 3;

FIG. 5 is a simplified illustration of a further additive manufacturing machine according to an embodiment of the invention;

FIG. 6 is a partial cross-sectional illustration of the filament straightener of FIG. 5;

FIG. 7 is an exploded illustration of the filament straightener of FIG. 5;

FIG. 8 is a partial cross-sectional illustration of a further filament straightener; and

FIG. 9 is an exploded illustration of the filament straightener of FIG. 8.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

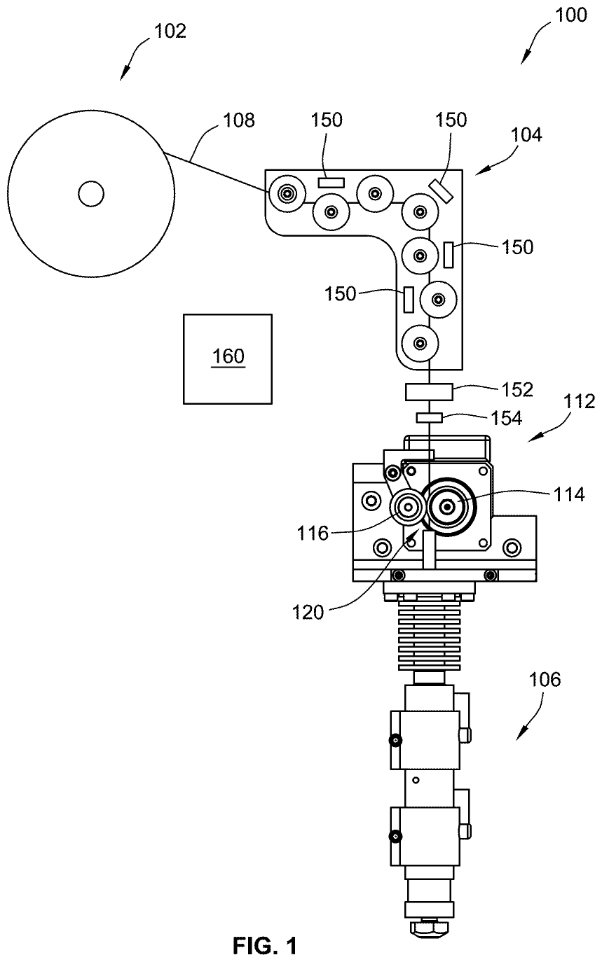

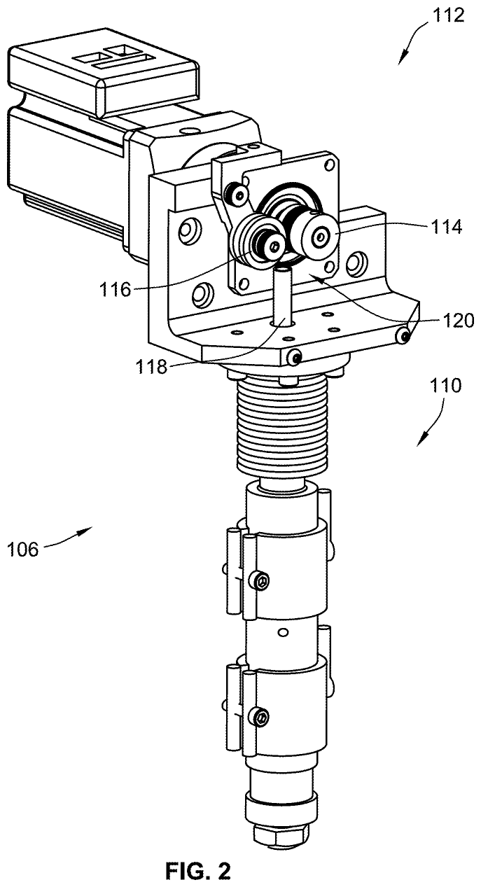

FIG. 1 illustrates, in simplified and schematic form, an additive manufacturing machine 100 in the form of additive manufacturing extruder that uses fused filament fabrication. The additive manufacturing machine 100 includes a filament supply 102, a filament straightener 104 and a filament extruder 106.

The filament supply 102 is illustrated in the form of a spool holding a continuous filament 108 of desired material in a wrapped state around the spool. The filament supply 10 could be on an independent structure from the filament straightener 104 and filament extruder 106, such as an independent cart, or could be mounted to a shared frame with the filament straightener 104 and filament extruder 106.

The filament extruder 106 may take many forms. One particular filament extruder 106 is disclosed in U.S. Application No. 62/384,522, filed Sep. 7, 2016 entitled High Flow Additive Manufacturing Extruder, the teachings and disclosure of which are incorporated herein in their entireties. The filament extruder 106 heats the filament 108 as it passes through a heated barrel assembly 110.

The filament extruder 106 includes a filament drive assembly 112 for driving the filament 108 into and through the barrel assembly 110. In particular, a drive hob 114 and guide roller 116 will mechanically guide and drive the filament 108 into guide tube 118 of the barrel assembly 110. Noticeably, a gap 120 is formed between the end of the guide tube 118 and the filament drive assembly 112 and particularly the drive hob 114 and guide roller of the filament drive assembly 112.

As noted above, thicker filaments, e.g. greater than 4 mm can retain significant memory of its curvature when spooled when being unwound from the filament supply 102. Unfortunately, when the filament has that curvature memory, it can cause difficulty feeding the filament 108 to and/or through the filament extruder 106. For example, the curvature memory of the filament 108 may cause the filament 108 curve around one the drive hob 114 or guide roller 116 such that it will not feed directly into guide tube 118.

To reduce the effects of the curvature memory in the filament 108, the filament 108 is passed through filament straightener 104 as it passes from the filament supply 102 to the filament extruder 106. The filament straightener 104, in this embodiment, subjects the filament to a plurality of bends that deform the filament 108 to remove some of the undesirable curvature memory.

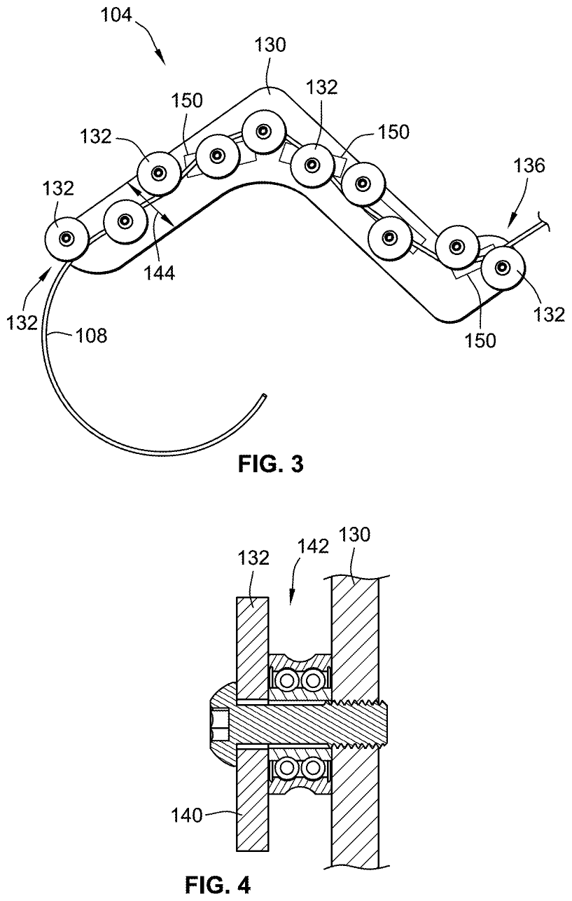

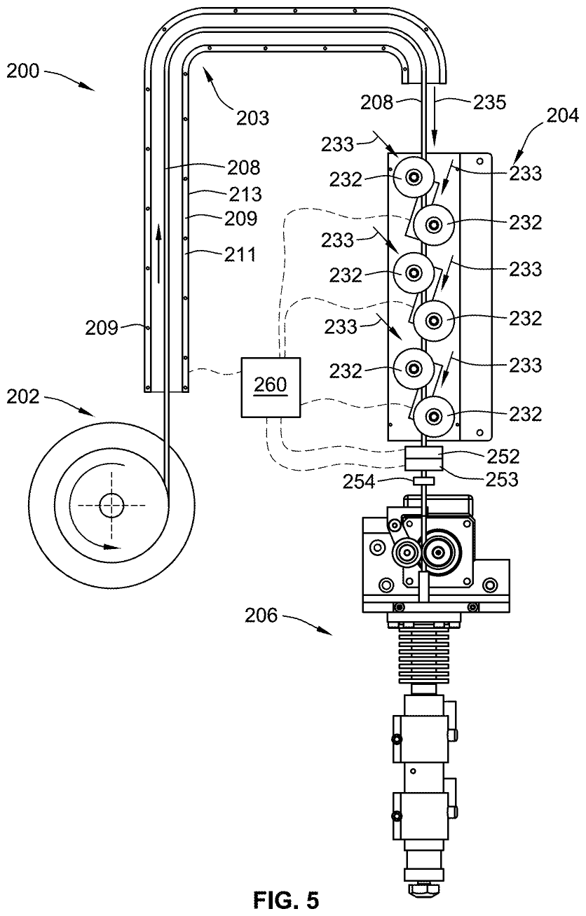

With additional reference to FIG. 3, the filament straightener 104 includes a base member 130 that supports a plurality of guide members 132 that define a filament flow path therebetween. In FIGS. 1 and 3, the filament flow path is illustrated by filament 108. The filament flow path of the filament straightener 104 extends between an inlet end 134 and an outlet end 136. The guide members 132 are spaced relative to filament flow path to cause the filament 108 to experience a plurality of bends as it flows from the inlet end 134 to the outlet end 136. In some embodiments, the spacing of the guide members 132 relative to the filament flow path and each other is such that the filament is plastically deformed as it is bent.

In the illustrated embodiment, the guide members 132 are in the form of rollers. Each roller rotates about a corresponding axis of rotation. The axes of rotation are generally perpendicular to the filament flow path. In some embodiments, the rollers could be mechanically driven by one or more motors. These driven rollers may be considered a feed mechanism for driving the filament 108 through the filament straightener 104. However, other feed mechanisms such as a drive hob/guide roller arrangement similar to drive hob 114 and guide roller 116 could be implemented upstream or downstream of the filament straightener 106 could be employed to help assist in driving the filament 108 along the filament flow path.

The guide members 132 may form flanges 140 for preventing the filament 108 from slipping off of the guide members 132. Accordingly, the flanges 140 and the base member 130 can form a retaining slot 142 therebetween for guiding the filament 108. Further yet, the guide member 132 could form the entire retaining slot.

Other embodiments are contemplated where the guide members 132 are simply stationary posts that define a fixed surface over which the filament 108 slides as it passes through the filament straightener. However, the use of rollers helps reduce friction and improves feeding of the filament through the additive manufacturing machine.

The guide members 132 can be adjustably mounted to the base member 130 to adjust the spacing of the guide members 132 relative to the filament flow path. Typically, the adjustment will include at least a component that is generally perpendicular to the filament flow path, which is illustrated by arrow 144. This can allow for increasing or decreasing the amount of bending applied to the filament 108 as it passes through the filament straightener 104. This will also allow for better processing of filaments of different size. The adjustability could be provided by a plurality of slots formed in the base member 130 that allow for the position of the guide members 132 to be adjusted.

To further facilitate removal of the curvature memory, the illustrated filament straightener 104 includes a plurality of heaters 150. The heaters 150 are positioned proximate the filament flow path to heat the filament 108. The heating of the filament can help release any curvature memory from the filament 108. A controller can be provided to control the temperature and heat output of the heaters 150.

In addition to the heaters 150, a cooling tube 152 (see FIG. 1) may be provided downstream of the guide members 132. Further yet, a further heater could be illustrated downstream of the filament straightener 104. The cooling tube can hold the filament 108 in a substantially straight orientation as it cools. This can cause the filament to lock in a new memory where the filament is straighter than before passing through the filament straightener 104. The length of the cooling tube 152 may be configured to allow the filament 108 to set in a straighter configuration before being fed to the filament drive assembly 112. Further, active cooling could be provided such as by fans or liquid cooling systems.

Further optional features may include a bend sensor 154 (see FIG. 1). The bend sensor can 154 can sense the amount of curvature memory that remains in the filament 108 after passing through the filament straightener 104. This information may be displayed back to a user for manual adjustment of the filament straightener 104. For instance, adjustment of the positioning of the guide members 132 may be required to increase or decrease the amount of bending of the filament 108 as it passes along the filament flow path. Also, for example, heating of the filament 108 from heaters 150 may be increased or decreased.

In some embodiments, a controller 160 may be operably controlled to the heaters 150 to automatically adjust the heaters 150 based on the information sensed from sensor 154. Further yet, in embodiments where the guide members 132 may be automatically adjusted, e.g. by use of actuators for repositioning the guide members 132, the controller 160 may be configured to automatically adjust the position of the guide members 132 to adjust the amount of bending provided by the guide members. Further yet, the controller could be preprogrammed with different set-up configurations for the guide members 132 and/or heaters 150 based on the characteristics of the filament 108, such as material type, material shape, material size, material composition, elastic modulus, yield strength, etc. As such, setup time of the additive manufacturing machine when switching between different filaments can be reduced.

Sizing and/or shaping dies may be added upstream, midstream, or downstream of the guide members 132 to adjust the size and/or shape of the filament 108 prior to being supplied to the filament extruder.

Ideally, the filament straightener 104 is configured such that the filament 108 is straight after it exits the filament straightener 104 and is fed to the filament extruder 106. However, in some embodiments sufficient straightening will still allow for some curvature memory. For example, it is desirably that a ratio of the radius of curvature before and after passing through the through the guide members 132 is less than 50%. This can be calculated by taking the radius of curvature of the filament 108 in a relaxed state after prior to passing through the filament straightener 104 relative to the radius of curvature of the filament 108 in a relaxed state after passing through the filament straightener 104. For example, using hypothetical numbers, if the radius of curvature prior to passing through the filament straightener 104 is 10 inches and the radius of curvature after passing through the filament straightener 104 is 20 inches, the ratio would be 50%. If the resulting radius of curvature was 40 inches, the ratio would be 25%.

FIG. 5 is a further embodiment of an additive manufacturing machine 200 according to the present invention. The additive manufacturing machine 200 includes a filament supply 202, a filament relaxer 203, a filament straightener 204 and a filament extruder 206.

The additive manufacturing machine 200 is similar to additive manufacturing machine 100 discussed above, unless expressly discussed below as being a difference, any of the features outlined above may be incorporated into or used in additive manufacturing machine 200.

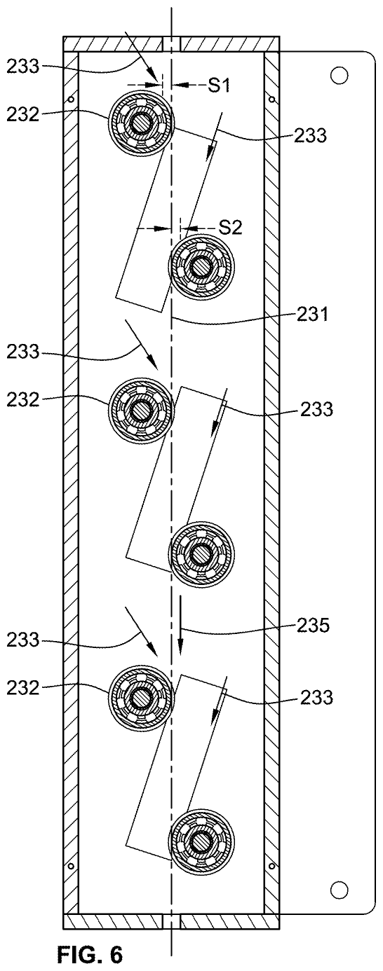

With additional reference to FIG. 6, in this embodiment, the filament straightener 204 is desired to be a substantially straight through filament straightener, wherein the flow path through the straightener 204 is substantially straight, i.e. there is no significant L-shaped bend as in the prior filament straightener 104. However, the spacing S1 and S2 (shown in exaggerated form for illustrative purposes) of the bottom of the valley of guide members 232 from a central axis 231 is designed to cause the filament 208 (see FIG. 5) to have repeated bending as it passes by the guide members 232. As such, it is preferred to have the spacing S1 and S2 from central axis 231 be less than half of the diameter of the filament to be straightened. Further, less than half can include being on the opposite side of the central axis 231. This again causes the filament to have repeated bends as it passes by each of the guide members 232. Arrows 233 are added to illustrate in an exaggerated manner the orientation of a filament 208 as the filament 208 passes through the guide members 232 and undergoes the repeated bending that, preferably, causes plastic deformation in the filament 208.

The spacing S1, S2 of the various guide members 232 may be the same or different when traveling along central axis 231 in direction of flow through the filament straightener 204, illustrated by arrow 235.

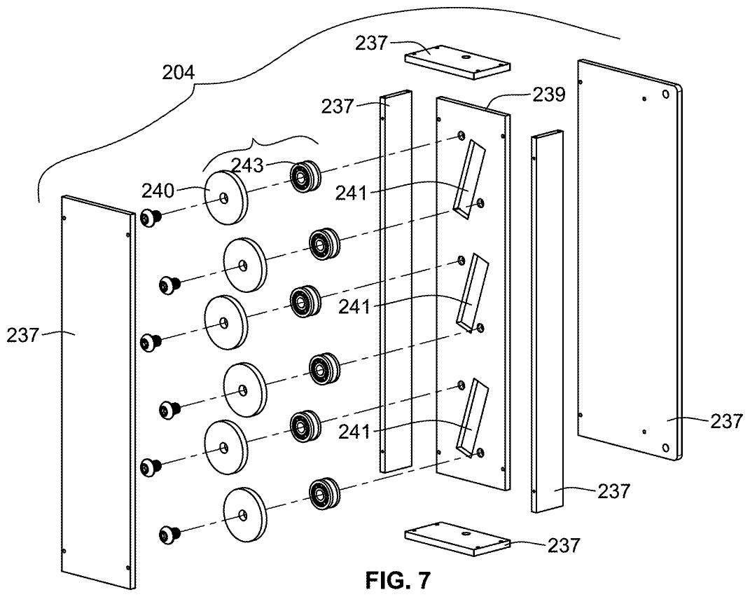

FIG. 7 illustrates the filament straightener 204 in exploded form. The filament straightener 204 includes an outer housing formed by panels 237. The top and bottom panels 237 define inlet and outlet openings through which the filament 208 enters and exits the filament straightener 204. Heaters are positioned between the inlet and outlet openings which may be considered inlet and outlet ends of the filament straightener 204.

Guide members 232 are mounted to a base member in the form of an inner mounting plate 239 that is mounted within the outer housing. The mounting plate 239 may include apertures 241 therethrough that cooperate with heaters (not shown). The heaters may overlap the apertures 241. In this embodiment, each guide member 232 includes a bearing 243 having an outer grooved surface that defines the valley in which the filament 208 is guided. Additionally, flange 240 is provided to help prevent the filament 208 from slipping off of the bearing 243. In the illustrated embodiment, the flange 240 is provided by a large washer but could be directly provided by bearing 243.

Similar to the prior embodiment, a cooling tube 252, heater 253 and bend sensor 254 may be downstream from the guide members 232 and upstream of the filament extruder 206. It is noted that cooling tube 252 and heater 253 could be provided by a component that can provide both heating and cooling to maintain the filament 208 at a desired temperature after exiting the guide members 232 prior to entering the filament extruder 206.

Unlike the prior embodiment, a filament relaxer 203 is provided upstream of the filament straightener 204. The filament relaxer 203 is a tube through which the filament 208 passes when it travels from filament supply 202 to the filament straightener 204. The filament relaxer 203 includes a heating arrangement, illustrated in the form of a heating coil 209 that wraps around an inner tube 211. The filament relaxer 203 pre-heats the filament 208 prior to the filament 208 entering the filament straightener 204. Some of the memory may be removed due to this pre-heating. Additionally, the pre-heating can help the filament straightener 204 remove memory within the filament 208. An outer insulative layer 213 may surround the heating arrangement and inner tube 211. In other embodiments, individual heaters could surround tube 211.

Controller 260 may control the various heaters, coolers, sensors and the filament extruder. The controller 260 may be multiple independent controllers that cooperate with one another to control each of the individual components.

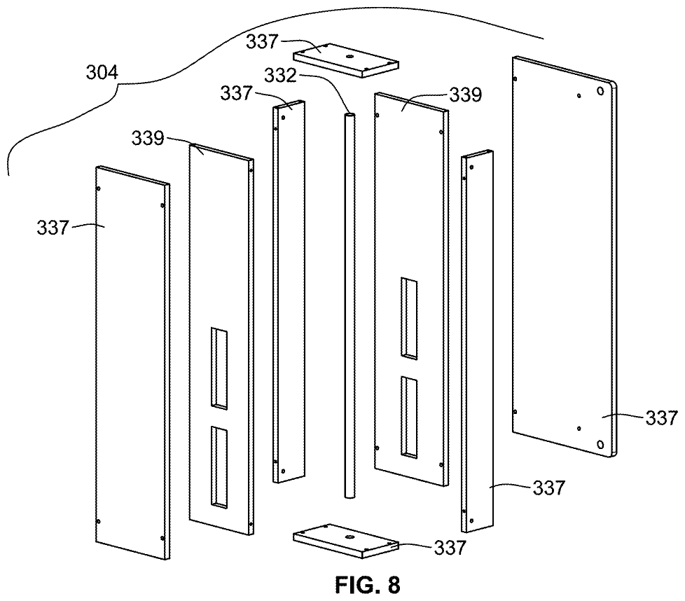

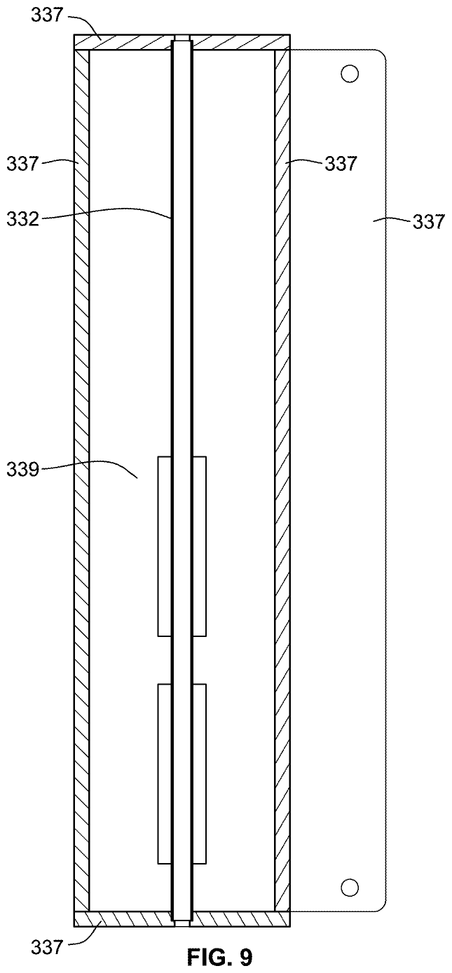

FIGS. 8 and 9 illustrate a further filament straightener 304. Filament straightener 304 uses a straightening tube 332 through which a filament (not shown) is passed to remove memory. This filament straightener 304 could be placed in exactly the same position as filament straightener 204 in FIG. 5.

The filament straightener 304 includes a housing formed from panels 337. In this embodiment, mounting plates 339 are provided for supporting various heaters (not shown).

In the illustrated embodiments, the inlet and outlet apertures in the top and bottom panels 337 are smaller in diameter than the inner diameter of the straightening tube 332. Further, opposed ends of the straightening tubes 332 are received in

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filament straightener for straightening a filament for use in an additive manufacturing machine comprising:
a base member;
a plurality of guide members attached to the base member, the plurality of guide members defining a filament flow path therebetween, the filament flow path extending between an inlet end and an outlet end, the guide members spaced relative to the filament flow path to cause a filament passing along the filament flow path between the inlet end and the outlet end to experience a plurality of bends.

2. The filament straightener of claim 1, further comprising at least one heater positioned adjacent the filament flow path to heat the filament as the filament passes from the inlet end toward the outlet end.

3. The filament straightener of claim 1, wherein the plurality of guide members is provided by a plurality of rollers, each roller rotating about an axis of rotation that is generally perpendicular to the portion of the filament flow path defined by the corresponding roller.

4. The filament straightener of claim 3, wherein the rollers are driven by at least one motor to drive filament along the filament flow path.

5. The filament straightener of claim 1, further comprising a feed mechanism for driving the filament along the filament flow path.

6. The filament straightener of claim 1, wherein the plurality of guide members is a plurality of stationary posts.

7. The filament straightener of claim 1, wherein at least one guide member is adjustable mounted to the base member to adjust a position of the guide member in a transverse direction relative to the filament flow path.

8. The filament straightener of claim 1, wherein a spacing of the plurality of guide members is such that the filament is plastically deformed as the filament is bent.

9. The filament straightener of claim 7, further comprising a bend sensor downstream from the plurality of guide members, further comprising a controller configured to adjust the spacing of the at least one guide member to adjust the amount of bend based on information from the bend sensor.

10. The filament straightener of claim 1, further comprising a sizing die for adjusting a size of the filament.

11. The filament straightener of claim 1, further comprising a shaping die for adjusting a shape of the filament.

12. The filament straightener of claim 1, wherein the plurality of guide members are positioned relative to the filament flow path such that a ratio of a radius of curvature of the filament before passing through the guide members to a radius of curvature of the filament after passing through the guide members is less than 50%.

13. The filament straightener of claim 2, further comprising cooling tube downstream from the heater and downstream of the plurality of guide members.

14. The filament straightener of claim 2, further comprising a heater downstream from the plurality of guide members.

15. A method of straightening filament for an additive manufacturing machine comprising:
passing filament through a straightener of claim 1.

16. An additive manufacturing machine comprising:
an extruder;
a spool of filament upstream of the extruder;
a straightener of claim 1 interposed between the extruder and the spool of filament.

17. The additive manufacturing machine of claim 16, further comprising at least one heater positioned adjacent the filament flow path to heat the filament as the filament passes from the inlet end toward the outlet end.

18. The additive manufacturing machine of claim 17, further comprising cooling tube downstream from the heater and downstream of the plurality of guide members and upstream of the filament extruder.

19. The additive manufacturing machine of claim 18, wherein the cooling tube is configured to allow the filament to set prior to entering the filament extruder.

20. The additive manufacturing machine of claim 16 further comprising a filament relaxer upstream of the straightener, the filament relaxer including a tube through which the filament passes prior to entering the straightener and a heater for heating the tube to heat the filament.

21. A method of straightening a filament for use in an additive manufacturing machine comprising:
repeatedly bending the filament to remove curvature memory in the filament prior to passing the filament to a filament extruder.

22. The method of claim 21, wherein repeatedly bending the filament utilizes a filament straightener including:
a base member;
a plurality of guide members attached to the base member, the plurality of guide members defining a filament flow path therebetween, the filament flow path extending between an inlet end and an outlet end, the guide members spaced relative to the filament flow path to cause a filament passing along the filament flow path between the inlet end and the outlet end to experience a plurality of bends.

23. The method of claim 21, wherein the repeated bending of the filament includes bending the filament to a sufficient degree such that the filament is repeatedly plastically deformed.

24. The method of claim 23, further comprising heating the filament during the step of repeatedly bending the filament.

25. The method of claim 24, further comprising cooling the filament after the step of heating the filament and after repeatedly bending the filament.
